(19) United States
(12) Patent Application Publication
(10) Pub. No.: US 2018/0260735 A1
(43) Pub. Date: Sep. 13, 2018

(54) TRAINING A HIDDEN MARKOV MODEL

(71) Applicant: International Business Machines Corporation, Armonk, NY (US)

(72) Inventors: Omer Arad, XXXXX (IL); Nir Mashkif, Ein Carmel (IL); Michael Masin, Haifa (IL); Alexander Zadorojniy, Haifa (IL); Sergey Zeltyn, Haifa (IL)

(21) Appl. No.: 15/452,749

(22) Filed: Mar. 8, 2017

(51) Int. Cl. G06N 99/00; G06N 5/04

(52) U.S. Cl. CPC G06N 99/005; G06N 5/04

(57) ABSTRACT

A computer program product, an apparatus and a method for training of an HMM. The method comprises applying a classifier that uses an HMM which was trained based on a training set, on a set of samples to provide an initial prediction; computing a first F1-score of the initial prediction measuring an accuracy of the initial prediction; selecting a misclassified sample by the classifier in the initial prediction; adding the misclassified sample to the training set; training the HMM using the misclassified sample to provide a modified HMM; applying the classifier using the modified HMM on the set of samples to provide a second prediction; computing a second F1-score of the second prediction; and comparing the first F1-score and the second F1-score; in response to a determination that the first F1-score is greater than the second F₁-score, removing the misclassified sample from the training set.

### TECHNICAL FIELD

The present disclosure relates to machine learning optimization in general, and to training of a HMM model, in particular.

### BACKGROUND

One of the machine learning applications for data that is represented as a sequence of observation over time is hidden Markov models. A hidden Markov model (HMM) is a statistical Markov model in which the system being modeled is assumed to be a Markov process with hidden states. A state in Markov models is directly visible to the observer, and therefore the state transition probabilities are the only parameters. In a hidden Markov model, the state is not directly visible, but the output, dependent on the state, is visible. Each state has a probability distribution over the possible output tokens. Therefore, the sequence of tokens generated by an HMM gives some information about the sequence of states. Hidden Markov models may be used in temporal pattern recognition such as speech, handwriting, gesture recognition, part-of-speech tagging, musical score following, partial discharges and bioinformatics.

HMM may be used in machine learning, by classifiers. The HMM may be trained using sequence of data. Quality of the classification provided by a classifier utilizing the HMM may be dependent on the quality of the training data. In some cases, adding new samples to the training data may not improve the performance of the classifier utilizing the HMM. For example, the HMM may be over-fitted for the training data.

### BRIEF SUMMARY

One exemplary embodiment of the disclosed subject matter is a computer program product comprising a non-transitory computer readable storage medium retaining program instructions, which program instructions when read by a processor, cause the processor to perform the steps of: obtaining a set of samples and labels thereof; applying a Hidden Markov Model (HMM)-based classifier on the set of samples to obtain a set of predicted labels, whereby providing an initial prediction, wherein the HMM-based classifier is configured to utilize an HMM to predict a label for a sample, wherein the HMM is trained based on a training set; computing a first F1-score of the initial prediction, wherein the first F1-score measures an accuracy of the initial prediction by comparing the predicted labels and the labels of the set of samples; selecting a misclassified sample from the set of samples, wherein the misclassified sample is a sample that is misclassified by the HMM-based classifier in the initial prediction; adding the misclassified sample to the training set; in response to said adding, training the HMM based on the training set, whereby providing a modified HMM; applying the HMM-based classifier using the modified HMM on the set of samples to obtain a second set of predicted labels, whereby providing a second prediction; computing a second F1-score of the second prediction; and comparing the first F1-score and the second F1-score, wherein in response to a determination that the first F1-score is greater than the second F1-score, removing the misclassified sample from the training set.

Another exemplary embodiment of the disclosed subject matter is a computer implemented method comprising: obtaining a set of samples and labels thereof; applying a Hidden Markov Model (HMM)-based classifier on the set of samples to obtain a set of predicted labels, whereby providing an initial prediction, wherein the HMM-based classifier is configured to utilize an HMM to predict a label for a sample, wherein the HMM is trained based on a training set; computing a first F1-score of the initial prediction, wherein the first F1-score measures an accuracy of the initial prediction by comparing the predicted labels and the labels of the set of samples; selecting a misclassified sample from the set of samples, wherein the misclassified sample is a sample that is misclassified by the HMM-based classifier in the initial prediction; adding the misclassified sample to the training set; in response to said adding, training the HMM based on the training set, whereby providing a modified HMM; applying the HMM-based classifier using the modified HMM on the set of samples to obtain a second set of predicted labels, whereby providing a second prediction; computing a second F1-score of the second prediction; and comparing the first F1-score and the second F1-score, wherein in response to a determination that the first F1-score is greater than the second F1-score, removing the misclassified sample from the training set.

Yet another exemplary embodiment of the disclosed subject matter is a computerized apparatus having a processor, the processor being adapted to perform the steps of: obtaining a set of samples and labels thereof; applying a Hidden Markov Model (HMM)-based classifier on the set of samples to obtain a set of predicted labels, whereby providing an initial prediction, wherein the HMM-based classifier is configured to utilize an HMM to predict a label for a sample, wherein the HMM is trained based on a training set; computing a first F1-score of the initial prediction, wherein the first F1-score measures an accuracy of the initial prediction by comparing the predicted labels and the labels of the set of samples; selecting a misclassified sample from the set of samples, wherein the misclassified sample is a sample that is misclassified by the HMM-based classifier in the initial prediction; adding the misclassified sample to the training set; in response to said adding, training the HMM based on the training set, whereby providing a modified HMM; applying the HMM-based classifier using the modified HMM on the set of samples to obtain a second set of predicted labels, whereby providing a second prediction; computing a second F1-score of the second prediction; and comparing the first F1-score and the second F1-score, wherein in response to a determination that the first F1-score is greater than the second F1-score, removing the misclassified sample from the training set.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a block diagram of an apparatus, in accordance with some exemplary embodiments of the disclosed subject matter; and

FIGS. 3A-3D show exemplary log of an execution of a method, in accordance with some exemplary embodiments of the disclosed subject matter.

### DETAILED DESCRIPTION

One technical problem dealt with by the disclosed subject matter is to improve the accuracy of classifiers utilizing HMMs.

In some exemplary embodiments, the HMM may be utilized in classification using a supervised learning scheme. The HMM may be trained based on a training set. The training set may comprise samples and labels thereof. A classifier utilizing the HMM (generally referred to as HMM-based classifier or HMM classifier) may be configured to analyze a sample, such as by extracting features thereof, and provide a predicted label of the sample according to the HMM. The HMM may be trained using the training set, in which a label is provided. The HMM may adapt itself to provide labeling such as observed in the training set.

A sample may be any object upon which labeling is performed. As an example, the sample may be, for example and without limiting the disclosed subject matter, an audio stream, an image, a biological sequence, an accelerometer readings, other sensor readings over time, or the like.

The labels may be potential classification of the sample. For example, in case of an image sample, the label may be MALE, FEMALE, or NONE. As another non-limiting example, in case of gesture recognition, samples generated by an accelerometer, may be labeled as comprising a first gesture, comprising a second gesture, not comprising any gesture, or the like.

Some applications may require manual sampling of the training samples, which may be difficult and imprecise. For example, test subjects may be asked to explicitly perform desired gesture and allow capturing of their movement. However, the timing of the gesture may vary within a sample, some gesture performance may be less accurate than other, and some test subjects may be confused and perform different gestures while providing an incorrect label thereof.

In some exemplary embodiments, the training set may be selected from a repository of potential training data. In some exemplary embodiments, a large training set may cause a lengthy training process with no guarantee for the effectiveness of the training. In some cases, smaller training sets may provide for an improved accuracy for HMM-based classifications. Additionally or alternatively, choosing of certain samples, such as wrong recordings, may lead to a wrong training. In some exemplary embodiments, weighted concatenation of samples, in which different samples are given a different weight based on the perceived quality thereof, may be cumbersome with no guarantee for effectiveness.

Another technical problem dealt with by the disclosed subject matter is to provide a training technique for enhancing training of HMM using private training data. The HMM may be initially trained using a benchmark training set. The private training data may include private data of a user or organization which do not wish to share their information. The private training data may include trade secrets, confidential data, private data, or the like. As an example, and without loss of generality, the private training data may comprise images of people which should not be disclosed. As another non-limiting example, the private training data may be audio recordings which were recorded during a military operation, the details of which should not be disclosed. Other non-limiting examples may be recordings which capture subjects in a non-modest manner, samples which include confidential medical information about subjects, or the like.

One technical solution is to retrain an initially trained HMM based on augmented training set comprising the initial training set and an additional sample that guarantees an improvement in the accuracy of the predictions of the classifier utilizing the HMM.

In some exemplary embodiments, an initial HMM-based classifier utilizing the initially trained HMM may be applied on a set of samples that comprise samples and labels thereof. The labels of the samples may be observed labels of the samples. The initially trained HMM may provide an initial predictions of labels for the samples. An initial accuracy score, such as an F₁-score of the initial prediction, may be computed. The initial accuracy score may measure the accuracy of the initial prediction by comparing the predicted labels and the labels of the set of samples. A set of misclassified samples may be identified. The set of the misclassified samples may comprise samples that were wrongly classified by the initial HMM-based classifier (i.e. their predicted label is different than their label), samples that were not detected by the initially trained HMM (i.e. the HMM-based classifier using the initial HMM did not provide a predicted label thereto), or the like.

In some exemplary embodiments, a misclassified sample may be selected from the set of misclassified samples. The misclassified sample may be added to the initial training set of the initially trained HMM to generate an augmented training set. In some exemplary embodiments, the initially trained HMM may be re-trained based on the augmented training set to provide a modified HMM.

In some exemplary embodiments, a determination whether the modified HMM is improved comparing to the initially trained HMM may be performed. Such a determination may be performed by comparing the initial accuracy score of the HMM-based classifier using the initial HMM with an accuracy score of a prediction of an HMM-based classifier utilizing the modified HMM over the set of samples. The HMM-based classifier utilizing the modified HMM may be applied on the set of samples to obtain a modified prediction of labels. An accuracy score of the modified prediction may be computed and compared with the initial accuracy score.

In case an improvement of the accuracy score is detected, the selected misclassified sample may be permanently added to the training set with the correct label thereof.

In case no improvement is detected or in case of a decrease in the accuracy score, the selected misclassified sample may be removed from the augmented training set.

The process may be repeated with selecting other misclassified samples and determining iteratively whether each of which increases the accuracy score. The process may be greedily repeated for all the samples in the set of misclassified samples. Additionally or alternatively, the list of misclassified samples may be re-computed after each improvement in the accuracy score.

One technical effect of utilizing the disclosed subject matter is to provide for an optimized training method that works on short-listed samples. The method may be performed in a linear or sub-linear time with respect to the set of samples. The method may provide for a relatively short training time.

Another technical effect of utilizing the disclosed subject matter is to provide for a less error-prone training process of HMMs. The disclosed subject matter may ensure improvement of accuracy of the HMM-based classifiers when adding additional samples. The disclosed subject matter may avoid potential over-fitting problems, and reduced accuracy caused by relying on low-quality samples in the training set.

Yet another technical effect may be to enable enhanced training using private data that does not need to be disclosed. The enhanced training may improve the accuracy with respect to the data of the owner of the private data, by relying on its samples. A benchmark HMM may be distributed, and adjusted in the deployed environment to improve its performance with respect to the deployed environment. Such adjustment is provided without a need to disclose confidential and private data.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

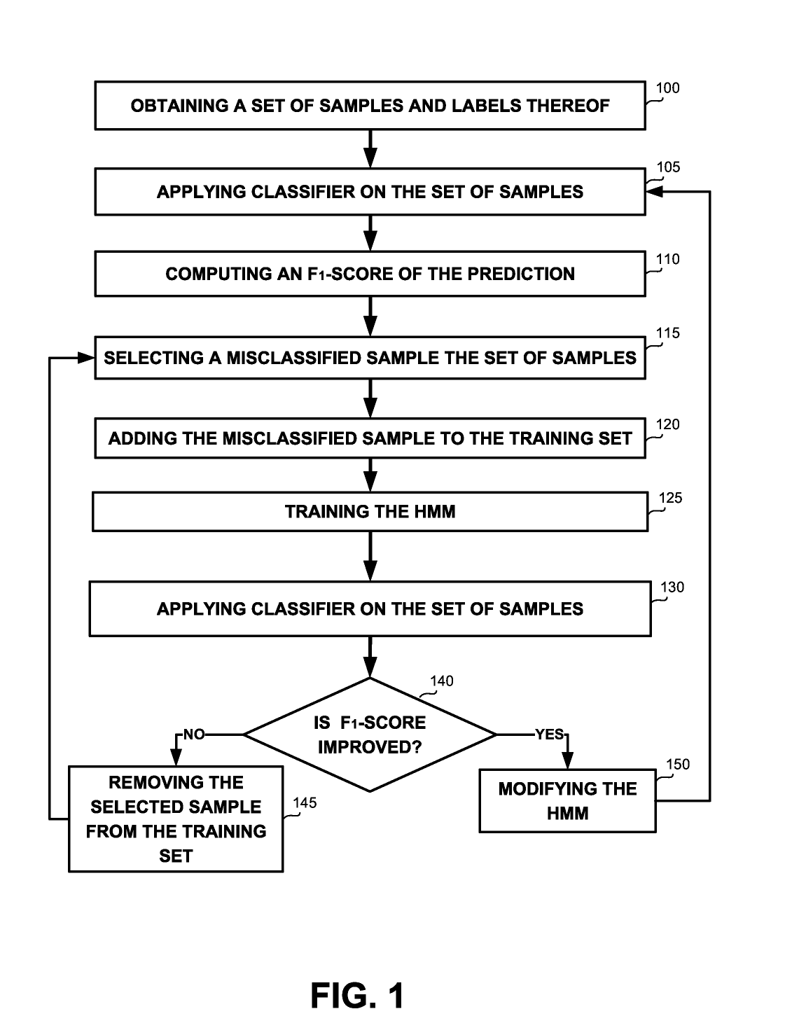

Referring now to FIG. 1 showing a flowchart diagram of a method, in accordance with some exemplary embodiments of the subject matter.

On Step 100, a set of samples and labels thereof may be obtained. In some exemplary embodiments, the set of samples may comprise observed samples collected based on observed cases, experiments, or the like. Additionally or alternatively, the set of samples may be retrieved from a repository of samples.

On Step 105, an HMM-based classifier may be applied on the set of samples. In some exemplary embodiments, the HMM-based classifier may utilize an HMM to perform the classification. In some exemplary embodiments, the HMM-based classifier may be configured to analyze the samples and predict a label for each sample. The prediction may be performed by utilizing the HMM. A set of predicted labels may be obtained by applying the HMM-based classifier on the set of samples. The set of predicted labels may provide an initial prediction.

In some exemplary embodiments, the prediction may be performed according to a training of the HMM utilized by the HMM-based classifier based on a training set. The training set may comprise samples and labels thereof, similar to the samples in the set of samples. The HMM may be adapted by the training to provide labeling such as observed in the training set.

In some exemplary embodiments, the training set may comprise public samples retrieved from a public dataset. As an example, the training set may comprise samples of DNA sequences labeled with their mapping in the human genome. This training set may be retrieved from the Human Genome Project (HGP) database, which is a public database of human genome sequences of the United States government.

In some exemplary embodiments, the set of samples and the training set may be obtained from different sources. The set of samples may comprise private data samples, that may not be disclosable to the source of the training set. The set of samples may be utilized to enhance the prediction accuracy of the HMM based on the private data samples. Additionally or alternatively, the set of samples may be utilized by a private entity to personalize the HMM based on private data of the entity.

Referring to the example of the samples of DNA, the training set may comprise DNA sequences of individuals related to a specific disease being searched in a private research laboratory. The private research laboratory may utilize the training set of the HGP database to initially train an HMM for classifying DNA sequences as causing the specific disease or not. The private research laboratory may enhance the accuracy of the HMM based on its private data, using its own set of samples, without exposing the private data to the HGP database.

Additionally or alternatively, the HMM may be developed and distributed by a distributer. The distributer may train the HMM using its proprietary training set. Additionally or alternatively, the distributer may train the HMM using publicly-available training set. The distributer may distribute the HMM to its clients, such as users who require the use of the HMM. The HMM may be distributed on its own or part of a program product which utilizes the HMM, such as an HMM-based classifier or another program product which utilizes the HMM-based classifier to perform its functionality. The client may receive the HMM and enhance it using her private data, which she may not want to disclose to the distributer.

As an example, consider a Gesture Recognition Software (GRS) which uses an HMM-based classifier. The distributer of the GRS may train an HMM using images of people performing gestures. The client purchasing the GRS may wish to enhance it to operate better for users who may be naked. For such a purpose, a set of samples of partially naked or fully naked people performing gestures may be generated by the client. As such images may be considered non-modest, the client and the people depicted in the samples, may wish to prevent the disclosure of the samples to third-parties, including the distributer. The client may employ the disclosed subject matter to enhance the GRS's prediction capabilities for her purposes without disclosing her private data.

On Step 110, an F₁-score of the initial prediction may be computed. In some exemplary embodiments, the F₁-score may measure an accuracy of the initial prediction by comparing the predicted labels and the labels of the set of samples. The F₁-score may be computed considering a precision p and a recall r of the prediction to compute the score. In some exemplary embodiments, p may be the number of true positive results divided by the number of all predicted positive results (i.e. true positive and false positive results). r may be the number of correct positive results divided by the number of actual positive results that should have been returned (i.e. true positive and false negative results).

In some exemplary embodiments, the F₁-score may be computed as:

$${F}_{1} = 2 \cdot \frac{p \cdot r}{p + r}$$

$$where \text{:} p = \frac{TP}{TP + FP} and r = \frac{TP}{TP + FN}$$

where: TP is the number of true positive results, FP is the number of false positive results, and FN is the number of false negative results.

On Step 115, a misclassified sample may be selected from the set of samples. In some exemplary embodiments, the misclassified sample may be a sample that is misclassified by the HMM-based classifier in the initial prediction. The misclassified sample may be a sample that its predicted label is wrong, that is undetected by the HMM-based classifier, or the like. In some exemplary embodiments, a list of the misclassified samples may be determined. The list may be ordered based on scores given to each sample. The selection may be performed in accordance with the order of the list. Additionally or alternatively, the selection from the list may be performed randomly.

On Step 120, the misclassified sample may be added to the training set of the HMM. The misclassified sample may be added to the training set with the correct label thereof. In some exemplary embodiments, the misclassified sample may be added to the training set logically without actually creating a new training set. In some exemplary embodiments, the misclassified sample may be added temporarily to the training set. The effect of its addition may be observed in Steps 125-140, after which a determination may be made whether or not to permanently add the misclassified sample to the training set.

On Step 125, the HMM may be trained to obtain a modified HMM. In some exemplary embodiments, the HMM may be re-trained based on the training set after adding the misclassified sample with the correct label thereto. Additionally or alternatively, in some cases the HMM may be trained using the misclassified sample alone, thereby adjusting the HMM to provide the same or similar results as if the HMM was trained using the augmented training set.

As will be appreciated by a person of ordinary skill in the art in view of the present disclosure, adding the misclassified sample may result, in some cases, in a reduction in accuracy of the HMM, or classification thereby. In other cases, the addition may result in an improvement in accuracy of the HMM.

On Step 130, the HMM-based classifier utilizing the modified HMM, may be applied on the set of samples. In some exemplary embodiments, a second set of predicted labels providing an alternative prediction may be obtained from the HMM-based classifier, when using the modified HMM.

On Step 140, a determination whether the F₁-score has been improved may be made. In some exemplary embodiments, a second F₁-score of the alternative prediction may be computed. The second F₁-score may measure an accuracy of the alternative prediction by comparing the predicted labels of the second set with the labels of the set of samples. The alternative F₁-score may be compared with the F₁-score, to determine if the accuracy has been improved.

In case the F₁-score has not been improved, i.e. the F₁-score is greater than or equal to the second F₁-score, on Step 145, the misclassified sample may be removed from the training set. The modified HMM may not be used, as its accuracy has been proven to be no better than that of the original HMM.

In some exemplary embodiments, in response to removing the misclassified sample from the training set, Step 115 may be repeated. In some exemplary embodiments, Step 115 may be repeated with the list of misclassified samples which were misclassified in Step 105. Additionally or alternatively, the misclassified sample may be removed from list of misclassified samples, prior to selecting another misclassified sample from the list of misclassified samples.

In case the F₁-score is improved, on Step 150, the modified HMM may be utilized instead of the original HMM. The modified HMM may have been proven to have an improved accuracy, and therefore may be used instead of the less accurate version thereof.

In some exemplary embodiments, Step 105 may be repeated with the modified HMM. In some exemplary embodiments, a new list of misclassified samples may be determined and used. Additionally or alternatively, the same list may be reused without creating a new list, thereby ensuring that the process terminates eventually. Additionally or alternatively, a combination of the above may be utilized by creating new lists and using them. After a predetermined number of iterations, the last list may be used until the process terminates. As another example, new lists may be created and used until utilizing a predetermined amount of resources, or until making a determination that the process may not terminate (e.g., determining that the size of the lists increases).

Additionally or alternatively, the selected misclassified sample may be removed from the list of misclassified samples.

In some exemplary embodiments, Steps 105-150 may be performed repeatedly until a desired f₁ F₁-score is reached. The F₁-score may reach its best value at 1 and worst at 0.

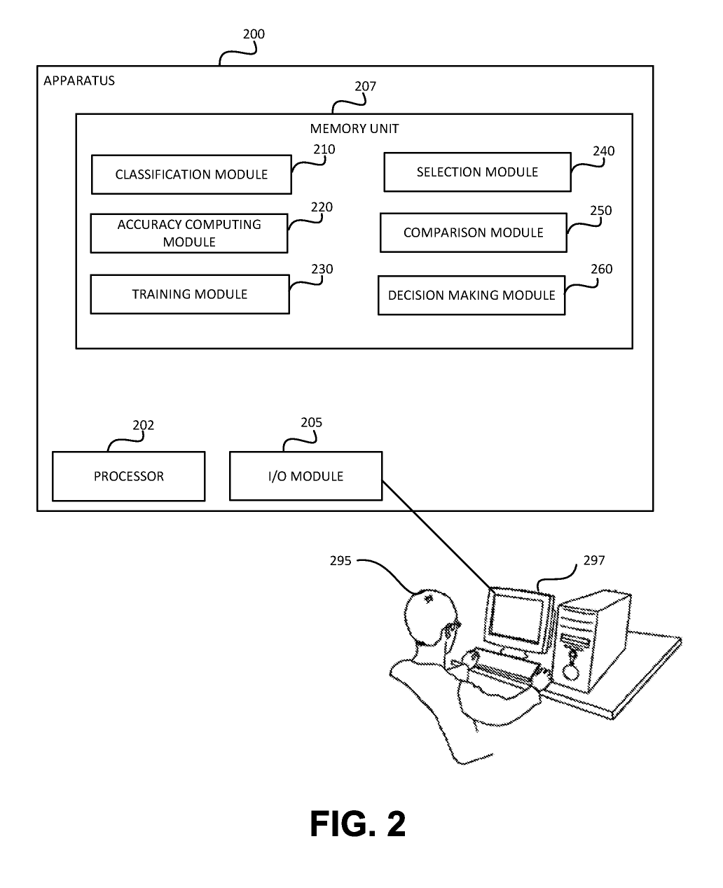

Referring now to FIG. 2 showing an apparatus in accordance with some exemplary embodiments of the disclosed subject matter.

In some exemplary embodiments, Apparatus 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Apparatus 200 or any of it subcomponents.

In some exemplary embodiments of the disclosed subject matter, Apparatus 200 may comprise an Input/Output (I/O) module 205. Apparatus 200 may utilize I/O Module 205 as an interface to transmit and/or receive information and instructions between Apparatus 200 and external I/O devices, such as a Workstation 297, computer networks (not shown), or the like. In some exemplary embodiments, I/O Module 205 may be utilized to provide an output to and receive input from a User 295, such as, for example receiving an initial training set, a set of samples, or the like; or providing a modified HMM, an augmented training set, or the like. It will be appreciated that Apparatus 200 can operate automatically without human intervention.

In some exemplary embodiments, Apparatus 200 may comprise Memory Unit 207. Memory Unit 207 may be a hard disk drive, a Flash disk, a Random Access Memory (RAM), a memory chip, or the like. In some exemplary embodiments, Memory Unit 207 may retain program code operative to cause Processor 202 to perform acts associated with any of the subcomponents of Apparatus 200.

In some exemplary embodiments, a Classification Module 210 may be an HMM-based classifier. Classification Module 210 may be configured to utilize an HMM to classify a set of sample. The set of samples may be obtained by I/O Module 205, and may comprise a label for each sample. Classification Module 210 may be utilized by Apparatus 200 to provide predictions for labels of samples based on the HMM. Classification Module 210 may be configured to generate a set of predicted labels for the set of samples based on the HMM.

In some exemplary embodiments, the HMM may be provided by I/O Module 205, retained in Memory Unit 207, or the like. In some exemplary embodiments, the HMM may be trained by an external device. Additionally or alternatively, the HMM may be generated and trained by Apparatus 200, such as by a Training Module 230. The HMM may be trained based on a training set. In some exemplary embodiments, the training set may be obtained by I/O Module 205 from an external database, may be retained in Memory Unit 207, or the like.

In some exemplary embodiments, an Accuracy Computing Module 220 may be configured to compute accuracy scores of predictions performed by Classification Module 210. In some exemplary embodiments, the accuracy score may be an F₁-score of the prediction. The F₁-score may measure the accuracy of the prediction by comparing the predicted labels and the original labels, such as the labels of the samples of the set of samples.

In some exemplary embodiments, a Selection Module 240 may be utilized to identify and select misclassified samples from sets of samples and add it to the training set. Selection Module 240 may be utilized to identify samples that are misclassified by Classification Module 210.

In some exemplary embodiments, Training Module 230 may be utilized to train HMMs utilized by Classification Module 210. In some exemplary embodiments, in response to Selection Module 240 adding a misclassified sample to the training set of the HMM, Training Module 230 may re-train the HMM based on the training set containing the misclassified sample and the correct label thereof. Additionally or alternatively, the re-training may be performed by training the initially trained HMM with the added misclassified sample. Training Module 230 may providing a modified HMM.

In some exemplary embodiments, a Comparison Module 250 may be utilized to compare between two accuracy scores of predictions performed by Classification Module 210. In some exemplary embodiments, one of the accuracy scores may be an accuracy score of a prediction performed by a classification using the original HMM. The second accuracy score may be an accuracy score of a prediction performed by a classification using the modified HMM (e.g., after the HMM was trained using the modified training set.

In some exemplary embodiments, a Decision Making Module 260 may be utilized to make a decision regarding the HMM based on a determination of Comparison Module 250. In response to a determination that the accuracy score before modification is greater than the accuracy score after the modification, Decision Making Module 260 may remove the misclassified sample from the training set and use the original HMM. Otherwise, in case the accuracy is improved, the modified HMM is used.

In some exemplary embodiments, Selection Module 240 may be invoked to repeatedly select new misclassified samples, and attempt to improve the HMM-based classification performed by Classification Module 210.

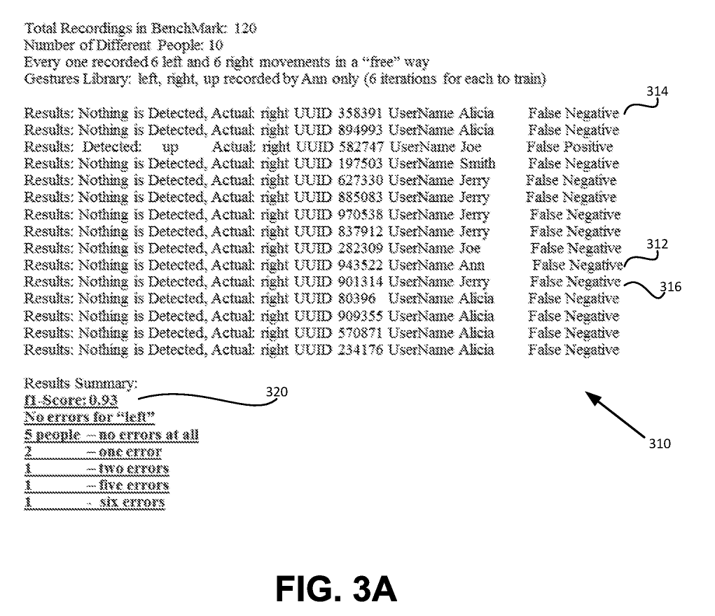

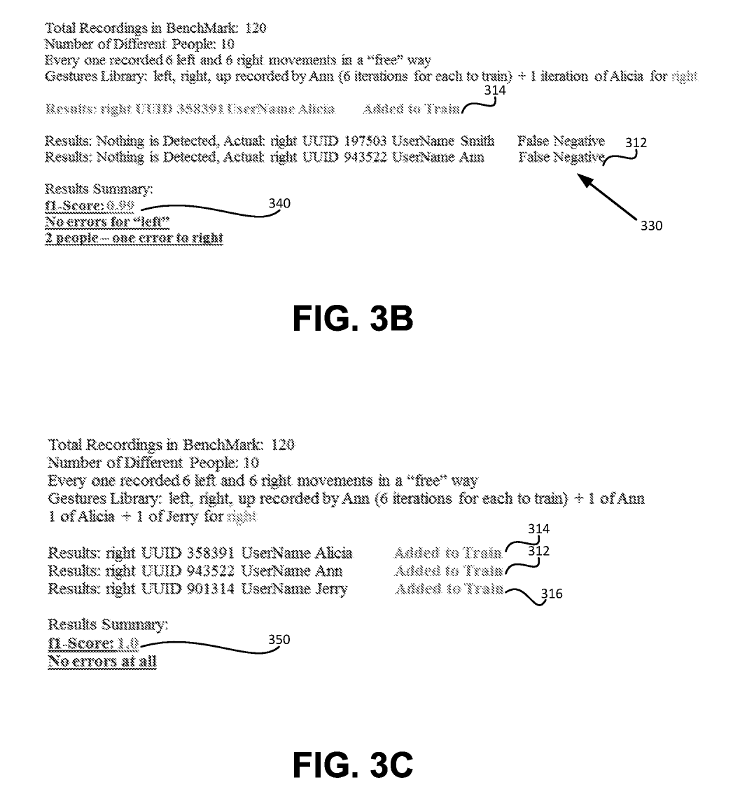

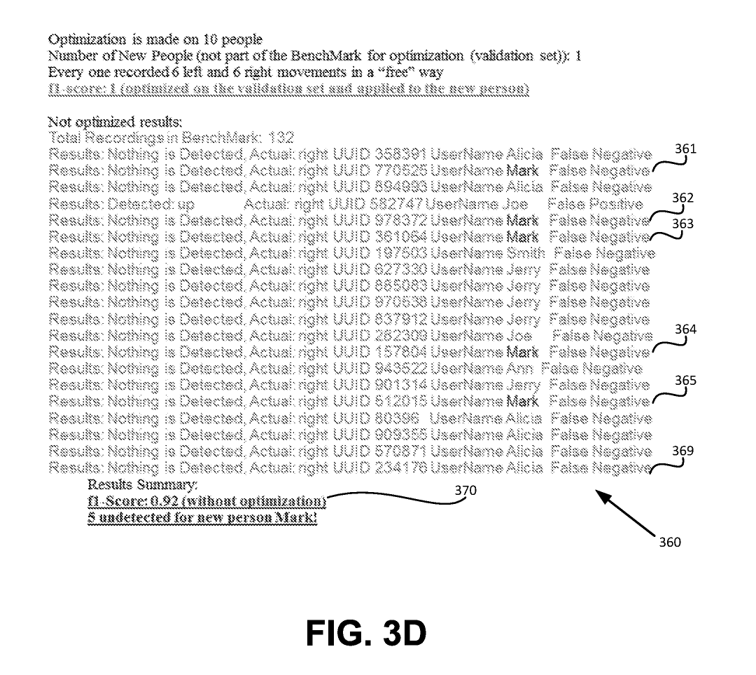

Referring now to FIGS. 3A-3D showing exemplary logs of an execution of a method, in accordance with some exemplary embodiments of the disclosed subject matter.

In some exemplary embodiments, the method of optimizing HMM training may be utilized for an HMM-based classification of gesture recognition. A gesture may be a spatio-temporal pattern which may be static, dynamic or both. The goal of gesture recognition may be to push the advanced human-machine communication to bring the performance of human-machine interaction close to human-human interaction. The HMM may be trained based on a public training set of a public source, and obtained therefrom. The HMM may be improved by a private entity developing a hand gesture recognition system to recognize real-time gestures.

In an embodiment of the disclosed subject matter, a benchmark of samples may comprise samples of gestures performed by different users, as being assessed by an accelerometer. Each gesture sample may be labeled as “left”, “up”, or “right” based on the gesture recorded by the user. The benchmark may comprise private data utilized by the private entity to enhance the accuracy of the HMM in classifying hand gestures. The private data may be private and may not be disclosable to the public or to the developer of the HMM, the HMM-based classifier, or the like.

In some exemplary embodiments, a classifier utilizing the HMM may be applied on samples of the benchmark. A set of misclassified samples may be obtained, such as Misclassified Samples Set 310, shown in FIG. 3A. In the exemplary log of the method, Misclassified Samples Set 310 comprises 15 samples that are misclassified by the HMM-based classifier when applied on the benchmark.

In response to applying the HMM-based classifier on the benchmark, a first F₁-score 320 may be computed. F₁-score 320 may measure the accuracy of the predictions of the HMM-based classifier over samples of the benchmark, by comparing the predicted results with the actual labels. F₁-score 320 is computed to be 0.93.

As an example, Misclassified Samples Set 310 may comprise Sample 312 of gesture 943522 which is labeled as right in the benchmark, has not been detected by the HMM-based classifier. Sample 312 may be indicated as a false negative result in computing F₁-score 320. Sample of gesture 582747 may be incorrectly labeled as “up” and may be indicated as a false positive.

Misclassified Sample Set 310 may be iteratively processed in accordance with its order. In each iteration it may be determined whether or not the accuracy is improved due to the addition of the misclassified sample.

In FIG. 3B, after one iteration, misclassified Sample 314 of gesture 358391 is added to the training set of the HMM. The HMM is retrained and applied on samples of the benchmark. A second Misclassified Samples Set 330 may be obtained. Misclassified Samples Set 330 may comprise two misclassified samples. A second F₁-score 340 may be computed to measure the accuracy of the prediction of the HMM-based classifier after adding Sample 314 to the training set. The second F₁-score 340 may be 0.99.

As the second F₁-score 340 is improved in comparing to the first F₁-score 320, Sample 314 may be kept in the training set.

The process may be repeated until F₁-score 350 which is equal to 1 is reached, as is depicted in FIG. 3C. Additionally or alternatively, in case maximal F₁-score is not reached, the process may terminate when all misclassified samples are processed. Samples 312, 314 and 316 may be added to the training set to reach F₁-score 350. No more errors may be detected by applying the HMM-based classifier on the benchmark.

It will be noted that Sample 316 is no longer misclassified in the log shown in FIG. 3B. However, Sample 316 is added to the training set and improves the accuracy of the HMM-based classifier nonetheless. In each iteration, a different sample is selected from the Misclassified Samples Set 310 (e.g., in accordance with its order).

In an alternative embodiment, the second Misclassified Samples Set 330 may be used for selecting therefrom after a sample is added to the training set and is kept there due to an improved F₁-score.

In FIG. 3D, the HMM-based classifier may be applied on a test set of samples. The test set may comprise additional samples to the samples of the benchmark, such as samples of gestures performed by an additional user, e.g. “Mark”. However, the additional samples may not be used for training. A set of misclassified samples may be obtained, such as Misclassified Samples Set 360. In the exemplary log of the method, Misclassified Samples Set 360 comprises 20 samples that are misclassified by the HMM-based classifier when applied on the test set. 5 of the samples, 361-365, are samples of the user “Mark”, that are added to the benchmark.

In response to applying the HMM-based classifier on the benchmark and test set, a first F₁-score 370 may be computed. F₁-score 370 may measure the accuracy of the predictions of the HMM-based classifier over samples of the benchmark and the test set, by comparing the predicted results with the actual labels. F₁-score 370 is computed to be 0.92.

Misclassified Sample Set 360 may be iteratively processed in accordance with its order, while excluding the additional samples added to the benchmark as the test set (i.e., samples of the user “Mark”). In each iteration it may be determined whether or not the accuracy is improved due to the addition of the misclassified sample.

The process may be repeated until F₁-score equal to 1 is reached or until all misclassified samples are processed. It may be noted that Samples 361-365 (the test set) have not been utilized in the optimization of the training. Sample 369 may be added to the training set to reach F₁-score equal to 1.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a non-transitory computer readable storage medium retaining program instructions, which program instructions when read by a processor, cause the processor to perform the steps of:
obtaining a set of samples and labels thereof;
applying a Hidden Markov Model (HMM)-based classifier on the set of samples to obtain a set of predicted labels, whereby providing an initial prediction, wherein the HMM-based classifier is configured to utilize an HMM to predict a label for a sample, wherein the HMM is trained based on a training set;
computing a first F₁-score of the initial prediction, wherein the first F₁-score measures an accuracy of the initial prediction by comparing the predicted labels and the labels of the set of samples;
selecting a misclassified sample from the set of samples, wherein the misclassified sample is a sample that is misclassified by the HMM-based classifier in the initial prediction;
adding the misclassified sample to the training set;
in response to said adding, training the HMM based on the training set, whereby providing a modified HMM;
applying the HMM-based classifier using the modified HMM on the set of samples to obtain a second set of predicted labels, whereby providing a second prediction;
computing a second F₁-score of the second prediction; and
comparing the first F₁-score and the second F₁-score, wherein in response to a determination that the first F₁-score is greater than the second F₁-score, removing the misclassified sample from the training set.

2. The computer program product of claim 1, wherein the program instructions are further adapted to cause the processor to: iteratively perform said computing the first f₁-score, said selecting, said adding, said training, said applying, said computing the second f₁-score, and said comparing.

3. The computer program product of claim 2, wherein in response to a determination, in a first iteration, that the second F₁-score is greater than the first F₁-score, utilizing the modified HMM in a second iteration, wherein the second iteration follows the first iteration.

4. The computer program product of claim 2, wherein in response to a determination, in a first iteration, that the second F₁-score is greater than the first F₁-score, removing the misclassified sample from the set of samples, whereby said selecting in a second iteration is performed from a reduced set of samples, wherein the second iteration follows the first iteration.

5. The computer program product of claim 1, wherein the set of samples is obtained from a first source, wherein the training set is obtained from a second source, wherein the first source is different than the second source.

6. The computer program product of claim 5, wherein the set of samples comprises private data samples, wherein the private data samples are non-disclosable to the second source, whereby enhancing prediction accuracy of the HMM-based classifier based on the private data samples.

7. The computer program product of claim 5, wherein the second source is a distributer of the HMM, wherein the first source is an entity utilizing the HMM obtained from the distributer, whereby the entity personalizes the HMM based on the set of samples of the entity.

8. A computer implemented method comprising:
obtaining a set of samples and labels thereof;
applying a Hidden Markov Model (HMM)-based classifier on the set of samples to obtain a set of predicted labels, whereby providing an initial prediction, wherein the HMM-based classifier is configured to utilize an HMM to predict a label for a sample, wherein the HMM is trained based on a training set;
computing a first F₁-score of the initial prediction, wherein the first F₁-score measures an accuracy of the initial prediction by comparing the predicted labels and the labels of the set of samples;
selecting a misclassified sample from the set of samples, wherein the misclassified sample is a sample that is misclassified by the HMM-based classifier in the initial prediction;
adding the misclassified sample to the training set;
in response to said adding, training the HMM based on the training set, whereby providing a modified HMM;
applying the HMM-based classifier using the modified HMM on the set of samples to obtain a second set of predicted labels, whereby providing a second prediction;
computing a second F₁-score of the second prediction; and
comparing the first F₁-score and the second F₁-score, wherein in response to a determination that the first F₁-score is greater than the second F₁-score, removing the misclassified sample from the training set.

9. The computer implemented method of claim 8 further comprising:
iteratively performing said computing the first f₁-score, said selecting, said adding, said training, said applying, said computing the second f₁-score, and said comparing.

10. The computer implemented method of claim 9 wherein in response to a determination, in a first iteration, that the second F₁-score is greater than the first F₁-score, utilizing the modified HMM in a second iteration, wherein the second iteration follows the first iteration.

11. The computer implemented method of claim 9, wherein in response to a determination, in a first iteration, that the second F₁-score is greater than the first F₁-score, removing the misclassified sample from the set of samples, whereby said selecting in a second iteration is performed from a reduced set of samples, wherein the second iteration follows the first iteration.

12. The computer implemented method of claim 8, wherein the set of samples is obtained from a first source, wherein the training set is obtained from a second source, wherein the first source is different than the second source.

13. The implemented method of claim 12, wherein the set of samples comprises private data samples, wherein the private data samples are non-disclosable to the second source, whereby enhancing prediction accuracy of the HMM-based classifier based on the private data samples.

14. The implemented method of claim 12, wherein the second source is a distributer of the HMM, wherein the first source is an entity utilizing the HMM obtained from the distributer, whereby the entity personalizes the HMM based on the set of samples of the entity.

15. A computerized apparatus having a processor, the processor being adapted to perform the steps of:
obtaining a set of samples and labels thereof;
applying a Hidden Markov Model (HMM)-based classifier on the set of samples to obtain a set of predicted labels, whereby providing an initial prediction, wherein the HMM-based classifier is configured to utilize an HMM to predict a label for a sample, wherein the HMM is trained based on a training set;
computing a first F₁-score of the initial prediction, wherein the first F₁-score measures an accuracy of the initial prediction by comparing the predicted labels and the labels of the set of samples;
selecting a misclassified sample from the set of samples, wherein the misclassified sample is a sample that is misclassified by the HMM-based classifier in the initial prediction;
adding the misclassified sample to the training set;
in response to said adding, training the HMM based on the training set, whereby providing a modified HMM;
applying the HMM-based classifier using the modified HMM on the set of samples to obtain a second set of predicted labels, whereby providing a second prediction;
computing a second F₁-score of the second prediction; and
comparing the first F₁-score and the second F₁-score, wherein in response to a determination that the first F₁-score is greater than the second F₁-score, removing the misclassified sample from the training set.

16. The computerized apparatus of claim 15, wherein the processor is further adapted to: iteratively perform said computing the first f₁-score, said selecting, said adding, said training, said applying, said computing the second f₁-score, and said comparing.

17. The computerized apparatus of claim 16, wherein in response to a determination, in a first iteration, that the second F₁-score is greater than the first F₁-score, removing the misclassified sample from the set of samples, whereby said selecting in a second iteration is performed from a reduced set of samples, wherein the second iteration follows the first iteration.

18. The computerized apparatus of claim 15, wherein the set of samples is obtained from a first source, wherein the training set is obtained from a second source, wherein the first source is different than the second source.

19. The computerized apparatus of claim 18, wherein the set of samples comprises private data samples, wherein the private data samples are non-disclosable to the second source, whereby enhancing prediction accuracy of the HMM-based classifier based on the private data samples.

20. The computerized apparatus of claim 18, wherein the second source is a distributer of the HMM, wherein the first source is an entity utilizing the HMM obtained from the distributer, whereby the entity personalizes the HMM based on the set of samples of the entity.
